(19) United States
(12) Patent Application Publication
(10) Pub. No.: US 2013/0220740 A1
(43) Pub. Date: Aug. 29, 2013

(54) Voice Recognition Apparatus For Elevator and Its Control Method

(71) Applicant: Jae Hyeok Yoo, Daegu (KR)

(72) Inventor: Jae Hyeok Yoo, Daegu (KR)

(21) Appl. No.: 13/389,552

(22) PCT Filed: Jun. 28, 2011
(86) PCT No.: PCT/KR2011/004709

§ 371 Date: Feb. 28, 2012

(30) Foreign Application Priority Data
Jun. 30, 2010 (KR) 10-2010-62456

(51) Int. Cl. B66B 1/34

(52) U.S. Cl. CPC B66B 1/34
USPC 187/380

(57) ABSTRACT

Disclosed is a voice recognition apparatus for an elevator and its control method which can be installed irrespective of an elevator manufacturer and make it possible to help a visually handicapped person or an audibly handicapped person to easily use the elevator with the aid of a voice recognition function. The voice recognition part according to the present invention includes a microphone for detecting a voice signal from an elevator passenger; a voice recognition control part which recognizes a voice signal detected by the microphone by way of a previously set voice recognition program, outputs a voice recognition command corresponding to a hall call and a floor selection and outputs a signal for a display of a voice recognition procedure by means of the audio recognition program and a result of the voice recognition; a voice recognition database for storing the voice recognition program and a previously set voice recognition information; a voice recognition time display part which is turned on and off in accordance with a display signal from the voice recognition control part; and a voice recognition audible display part for outputting a voice signal in accordance with a display signal from the voice recognition control part.

### TECHNICAL FIELD

The present invention relates to a voice recognition apparatus for an elevator and its control method, and in particular to a voice recognition apparatus for an elevator and its control method which can be installed irrespective of an elevator manufacturer and make it possible to help a visually handicapped person or an audibly handicapped person to easily use the elevator with the aid of a voice recognition function.

### BACKGROUND ART

Elevator is generally equipped with an indication window disposed at a hall provided at every floor of a multiple-story building for indicating the position of an elevator, and a hall call button calling an elevator, and in the interior of an elevator are provided floor selection buttons for a passenger to select a desired floor.

FIG. 1 is a perspective view illustrating the construction of a conventional elevator. As shown therein, the elevator 10 is formed of an elevator hall 11 disposed at one side of a building and waiting for a passenger to get on or off an elevator 10, and a rectangular riding part 20 is disposed between an elevator door 21 and the elevator hall 11.

A hall call button 22 is installed at one side of the elevator hall 11 for calling the elevator 10, and an operation panel 23 is installed along with a plurality of floor selection buttons 24 in the inner side of the riding part 20.

The passenger who wants to get on an elevator 10 calls the elevator 10 by pushing the hall call button 22, and the passenger in the called elevator 10 can move to a desired floor by designating a desired floor by pushing the floor selection button 24 disposed in the interior of the elevator.

The conventional elevator 10 has a problem in that when a lot of passengers are in the elevator, it is impossible for each passenger to select a desired floor. In order to overcome the above problems, in case of a large size elevator, two sets of buttons are provided in the interior of the elevator for passengers to select desired floors.

In case of an elevator generally used by a number of people as in a hospital, an airport, a terminal, etc, since a multiple passengers push the buttons, a variety of pathogenic bacteria or common bacteria live at the input buttons of each floor, so it is needed to always clear the buttons to keep the elevator clean.

A visually handicapped person needs to search for a hall call button for a selection of a desired floor or a button with Braille. In this case, the visually handicapped person wrongly selects a button while searching the buttons.

In addition, a conventional elevator is hard to maintain because each elevator manufacturer use different communication protocols, and the parts performing the same functions use different protocols by the manufacturers, so the parts are compatible with each other.

### DISCLOSURE OF INVENTION

Accordingly, the present invention is made to overcome the above problems and it is an object of the present invention to provide a voice recognition apparatus for an elevator and its control method which can be installed irrespective of manufacturers, and a visually handicapped person or an audibly handicapped person can easily use with the aid of a voice recognition function.

To achieve the above objects, there is provided a voice recognition apparatus for an elevator comprising a voice recognition part for allowing a procedure of recognizing a hall call voice and a floor selection voice of a passenger and a result of the voice recognition and outputting a voice recognition command corresponding to the hall call and the floor selection; a button input part for detecting the hall call signal and the floor selection signal from the passenger, a control par for outputting an operation control signal in accordance with a voice recognition command from the voice recognition part and a hall call signal and a floor selection signal detected from the button input part; a protocol conversion part for converting the elevator operation control signal from the control part into a communication protocol of a previously set elevator manufacturer based on the manufacture of the elevator; a transceiver from transmitting an operation control signal converted by the protocol conversion part, and a display part for allowing the hall call signal and the floor selection signal to be recognized by the passenger in accordance with an operation control signal from the control part.

The present further comprises a protocol setting part by which the protocol conversion part inputs a communication protocol information by the elevator manufacturer.

The voice recognition part according to the present invention includes a microphone for detecting a voice signal from an elevator passenger; a voice recognition control part which recognizes a voice signal detected by the microphone by way of a previously set voice recognition program, outputs a voice recognition command corresponding to a hall call and a floor selection and outputs a signal for a display of a voice recognition procedure by means of the audio recognition program and a result of the voice recognition; a voice recognition database for storing the voice recognition program and a previously set voice recognition information; a voice recognition time display part which is turned on and off in accordance with a display signal from the voice recognition control part; and a voice recognition audible display part for outputting a voice signal in accordance with a display signal from the voice recognition control part.

The voice recognition control part outputs a flickering signal and a voice signal so that a passenger can recognize that a voice recognition is being performed by way of the audio recognition program in visual and audible ways.

In addition, the voice recognition time display part comprises a first lamp which is turned on when a voice recognition command is outputted from the control part; and a second lamp which is turned on when a voice recognition command is not outputted from the voice recognition part.

To achieve the above objects, there is provided a method for controlling a voice recognition apparatus for an elevator, comprising (a) a step in which a control part detects an operation control signal of an elevator from at least one among a voice recognition part and a button part; (b) a step in which the control part judges if a voice recognition command is outputted from the voice recognition part when an elevator operation control signal is detected by way of the voice recognition part in the step (a); (c) a step in which the control part outputs a corresponding operation control signal when the voice recognition command is outputted in the step (b); and (d) a step in which a protocol conversion part converts an operation control signal outputted in the step (c) into a previously set communication protocol of an elevator manufacturer, and the converted operation control signal is transmitted to the outside by way of the transceiver.

The step (a) includes a sub-step in which the voice recognition part outputs a signal for displaying a procedure of recognizing a hall call voice and a floor selection voice of a passenger by way of a previously set voice recognition program and a result of the voice recognition.

The display signal of the procedure of recognizing the voice is a flickering signal and a voice signal casing a passenger to recognize that a voice recognition is being performed by means of the voice recognition program in visual and audible ways.

The signal displaying a result of the voice recognition causes a previously set first lamp to turn on when a voice recognition command is outputted from the voice recognition control part and causes a previously set second lamp to turn on when a voice recognition command is not outputted from the voice recognition control part.

### ADVANTAGEOUS EFFECTS

The present invention has an advantage in that a previously installed elevator can be changed to operate with a voice recognition function by exchanging a hall call part and an operation panel.

The present invention makes it possible to help a visually handicapped person or an audibly handicapped person conveniently use an elevator.

The voice recognition apparatus according to the present invention can be easily installed irrespective of the manufacture of an elevator.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating the construction of a conventional elevator;

FIG. 2 is a block diagram illustrating the construction of a voice recognition apparatus for an elevator according to the present invention;

FIG. 3 is a view illustrating an example of a hall call part with a voice recognition apparatus for an elevator according to the present invention;

FIG. 4 is a view illustrating an example of an operation panel applied with a voice recognition apparatus for an elevator according to the present invention; and

FIG. 5 is a flow chart of a control process of a voice recognition apparatus for an elevator according to the present invention.

### BEST MODES FOR CARRYING OUT THE INVENTION

The voice recognition apparatus for an elevator and its control method according to the present invention will be described with reference to the accompanying drawings.

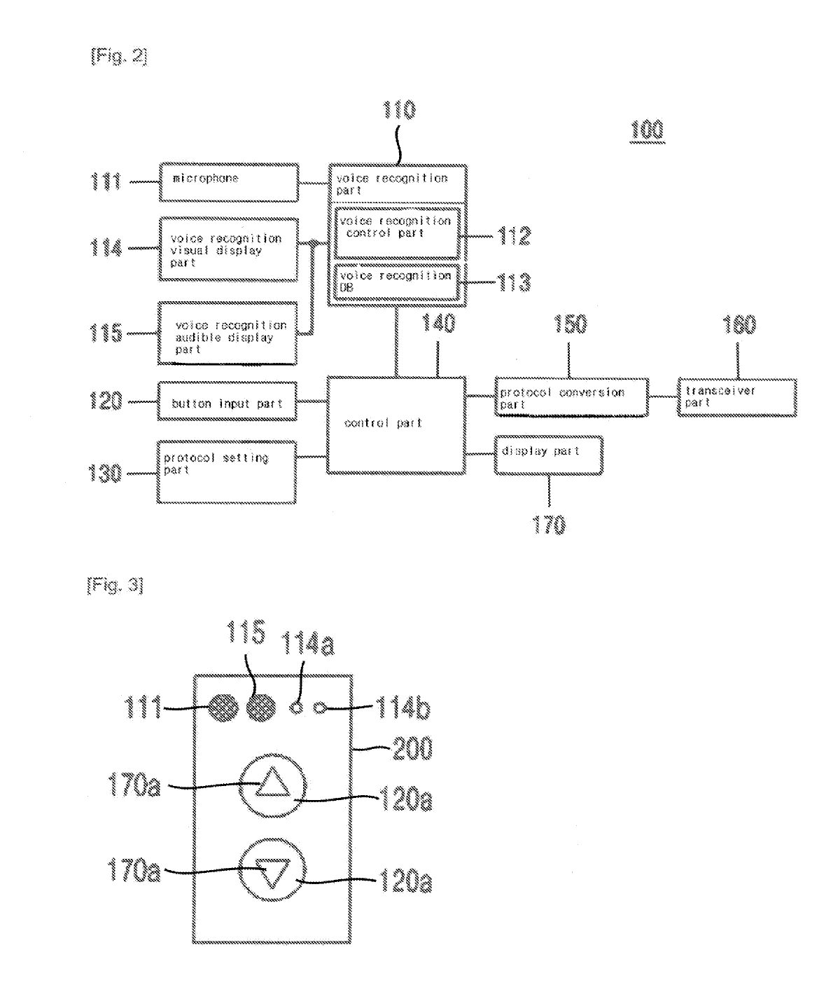

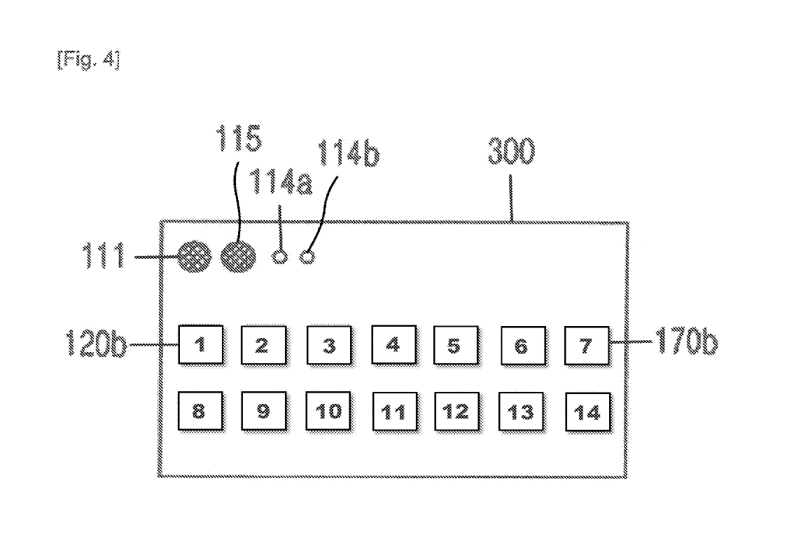

FIG. 2 is a block diagram illustrating the construction of a voice recognition apparatus for an elevator according to the present invention, and FIG. 3 is a view illustrating an example of a hall call part with a voice recognition apparatus for an elevator according to the present invention, and FIG. 4 is a view illustrating an example of an operation panel applied with a voice recognition apparatus for an elevator according to the present invention.

As shown in FIGS. 2 and 3, the voice recognition apparatus 100 for an elevator according to the present invention comprises a voice recognition part 110, a button input part 120, a protocol setting part 130, a control part 140, a protocol conversion part 150, a transceiver part 160 and a display part 170.

For a procedure of recognizing a hall call voice and floor selection voice of a passenger and a function of displaying a voice recognition result and a function for outputting a voice recognition command corresponding to a hall call and floor selection, the voice recognition part 110 comprises a microphone 111, a voice recognition control part 112, a voice recognition database 113, a voice recognition time display part 114, and a voice recognition audio display part 115, all of which are installed at the hall call part 200 and the operation part 300, respectively.

The microphone 111 is designed to detect a hall call from a passenger to get on an elevator and a passenger already in the elevator or a voice signal for a selection of a floor to move to and is installed at a hall call part 200 installed at an elevator hall and an operation panel 300 installed in the interior of the elevator.

The voice recognition part 112 recognizes a voice signal related to a hall call detected from the microphone 111 or a voice signal related to a floor selection by way of a set voice recognition program and outputs a voice recognition command corresponding to a hall call and floor selection.

The voice recognition program is designed to prepare for a voice from an elevator passenger and a voice information previously stored in the voice recognition database 113 and detects an information of a hall call and an operation floor by detecting a key word from the voice.

The voice recognition program detects a voice of a passenger by way of the microphone 111 and records at a storing part such as the voice recognition database 113 and filters a noise removal and amplification and voice frequency from the recorded voice to a high frequency band and a low frequency band and analyzes and detects a key frequency, thus outputting an amplified information, and detects a word and phoneme of the voice and compares the feature of the voice with the voice information stored in the voice recognition database 113, whereby to extract and read the voice recognition command (for example, key words) needed for the operation of the elevator corresponding to the language recognized depending on the features of the voice and the mathematically analyzed phoneme, group and languages.

The voice recognition commands (for example, key words) are voice information for controlling the operation of the elevator, namely, words related to, in case of hall call, the up and down movements like “up”, “going up”, “down”, “going down”, and in case of floor selection, words related to the floor like “first floor”, “first basement”, or “fifth floor”.

The voice recognition program basically serves to judge a non recognition word or a no-key word and a key word by analyzing the voice information stored in the voice recognition database 113 by way of a sounding check in such a way to recognize a corresponding voice signal, reject or accept the same. Here the voice recognition program serves to recognize a sound or dialogue sound in order to eliminate an error operation which might occur in the voice recognition program.

The recognized voices are tested to enhance their reliability by checking if a passenger made a sound using a non-recognition work by means of an anti-phoneme and a key word needed for an elevator operation by way of a phoneme removal. When the reliability of the key word (operation command) recognized by way of the check is high, the recognition is performed, thus providing corresponding operation information. When the recognized key word has a low reliability, the recognition is not performed, and the operation information is not supplied. In this case, a signal indicating an error in the voice recognition is generated.

The voice recognition control part 112 outputs a signal for displaying a voice recognition procedure by way of the voice recognition program and a result of the voice recognition.

The voice recognition control part 112 outputs a flickering signal of a previously set pattern and a voice signal in a form of a display signal so that a passenger can recognize the facts that a voice recognition is activated by means of a voice recognition program in a visual and audible way.

The passenger can recognize the voice recognition time display part 114 turning on and off at a regular time interval with the aid of the flickering signal and then can know that the voice from the passenger is being recognized by means of the voice recognition control part 112.

In addition, it is possible to allow the sounded voice to be recognized by means of the voice recognition control part 112 in such a way that the voice signal allowing judging the recognition of voice signal (for example, recorded sound of voice from the passenger) is outputted by way of the voice recognition audible display part 115.

When the voice recognition procedure is completed, the voice recognition control part 112 outputs a voice recognition command and a re-input command depending on a result of the same and outputs a flickering signal for a display of a result.

The voice recognition database 113 stores the voice recognition information previously set along with the voice recognition program and recorded information of voice from a passenger.

The voice recognition visual display part 114 is turned on and off depending on a display signal from the voice recognition control part 112 and is formed of a first lamp 114a and a second lamp 114b.

The first lamp 114a is designed to turn on/off when the voice recognition command is outputted as a result of the operation of the voice recognition from the voice recognition control part 112, by means of which it is possible for the passenger to check if the voice recognition is normally done.

The second lamp 114b is designed to turn on/off when the voice recognition command is not outputted, and the re-input command is outputted as a result of the operation of the voice recognition from the voice recognition control part 112, by means of which it is possible for the passenger to check that the voice recognition is not normally performed.

The second lamp 114b is designed to turn on/off when the flickering signal of a previously set program is outputted so that the voice recognition by means of the recognition program from the voice recognition control part 112 is performed, by means of which it is possible for the passenger to check that the voice from the passenger is being normally recognized.

The voice recognition audible display part 115 outputs a previously set voice signal (for example, hall call, operation floor, re-input request) in accordance with a voice output display signal from the voice recognition control part 112.

The button input part 120 is installed at the hall call part 200 and the operation panel 300, respectively, and serves to detect a hall call signal and a floor selection signal from the passenger.

The protocol setting part 130 is to determine the communication protocol to be used by the protocol conversion part 150 and detects the information of an elevator manufacturer.

The control part 140 outputs a control signal for an operation of an elevator in accordance with a voice recognition command from the voice recognition part 110 and a hall call signal and a floor selection signal from the button input part 120.

The protocol conversion part 150 converts an operation control signal from the control part 14 into a communication protocol of the elevator manufacturer previously set in accordance with the elevator manufacturer.

The transceiver 160 serves to transmit and receive the operation control signal converted by means of the protocol conversion part 150.

The display part 170 helps the passenger to recognize the hall call signal and the floor selection signal in accordance with an operation control signal from the control part 140.

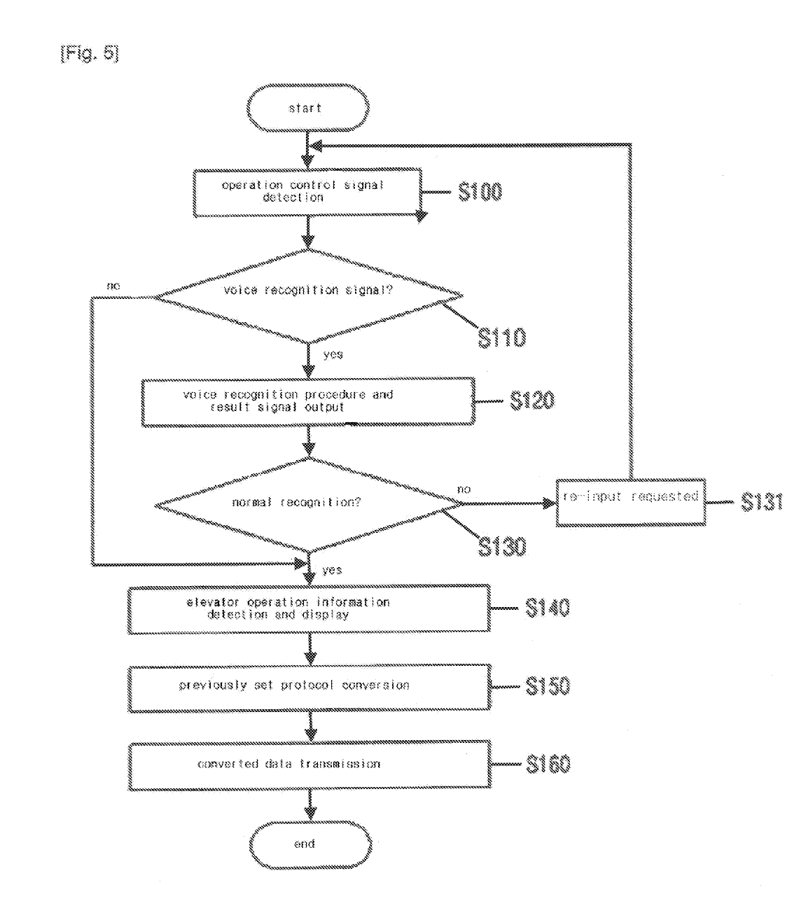

FIG. 5 is a flow chart of the control procedure of the voice recognition apparatus for an elevator according to the present invention.

As shown in FIGS. 2 to 5, when the control part 140 detects an operation control signal of the elevator from at least one among the voice recognition part 110 and the button part 120 in a step S100, and it is judged if the operation control signal is inputted from the voice recognition part 110 in a step S110.

In the step S110, if the elevator operation control signal is inputted by way of the voice recognition part 110, the control part 140 outputs a signal for displaying a procedure of recognizing the hall call voice and the floor selection voice of the passenger by way of the previously set voice recognition program and a result of the voice recognition in a step S120, and the control part 140 judges if a voice recognition command is outputted from the voice recognition part 110 in a step S130, and the control part 140 outputs a corresponding operation control signal in a step S140 when the voice recognition command is outputted in the step 130.

The operation control signal outputted in the step S140 is converted into a communication protocol of the elevator manufacturer previously set in the protocol conversion part 150 in a step S150, and the converted operation control signal is transmitted to the outside by way of the transceiver part 160 in a step S160.

The display signal of the procedure of recognizing the voice in the step S120 is outputted as a flickering signal and a voice signal so that the passenger can recognize that the voice recognition is being performed by means of the voice recognition program by way of visual and audible ways.

The signal displaying a result of the voice recognition causes the first lamp 114a to turn on when a voice recognition command is outputted from the voice recognition control part 112, and causes the second lamp 114b to turn on when a voice recognition command is not outputted from the voice recognition control part 112.

So far, the preferred embodiments of the present invention has been described, but it is obvious that an ordinary person skilled in the art can change and modify the present invention is various ways without escaping the scope of the concept and field of the present invention recited in the following claims.

| | |
|---|---|
| 100: voice recognition apparatus | 110: voice recognition part |
| 111: microphone | 112: voice recognition control part |
| 113: voice recognition DB | 114: voice recognition time |
| | display part |
| 114a: first lamp | 114b: second lamp |
| 115: voice recognition | |
| audible display part | |
| 120: button input part | |
| 120a: hall call button part | 120b: floor selection button part |
| 130: protocol setting part | 140: control part |
| 150: protocol conversion part | 160: transceiver part |
| 170: display part | 170a: hall call display part |
| 170b: floor selection display part | 200: hall call part |
| 300: operation panel | |

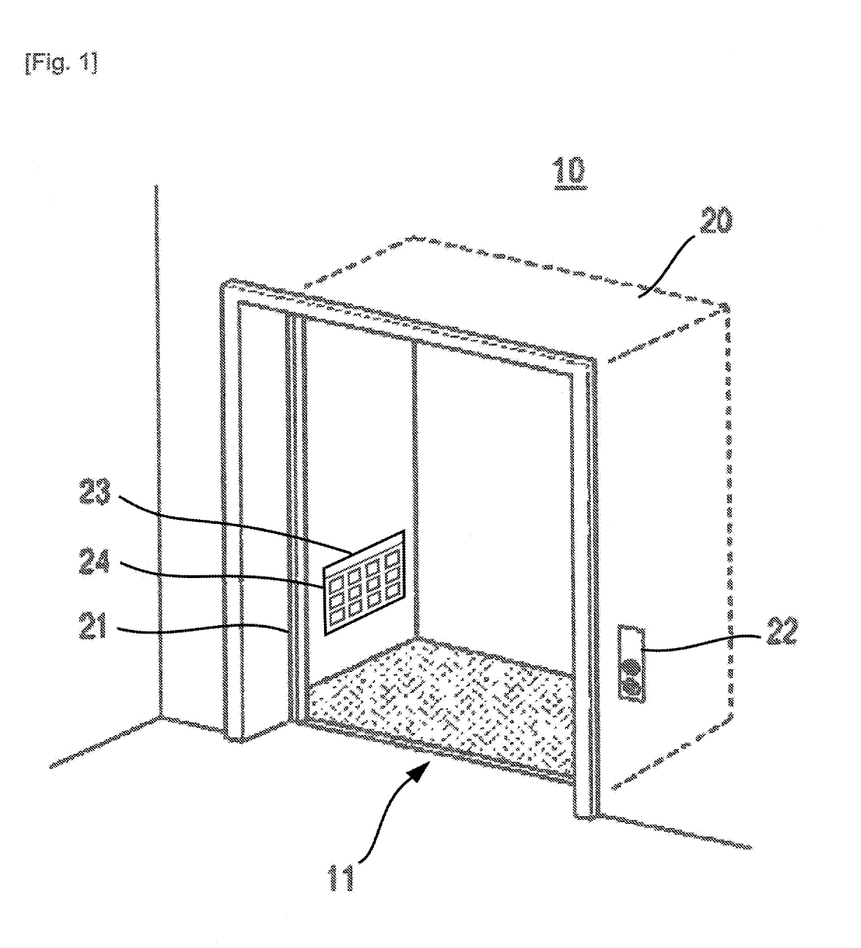

### FIG. 1

### FIG. 2

111: microphone
114: voice recognition visual display part
115: voice recognition audible display part
120: button input part
130: protocol setting part
110: voice recognition part
112: voice recognition control part
113: voice recognition DB
140: control part
150: protocol conversion part
160: transceiver part
170: display part

### FIG. 3

### FIG. 4

### FIG. 5

start
S100: operation control signal detection
S110: voice recognition signal?
   yes
   no
S120: voice recognition procedure and result signal output
S130: normal recognition?
S131: re-input requested
S140: elevator operation information detection and display
S150: previously set protocol conversion
S160: converted data transmission
   end

1. A voice recognition apparatus for an elevator, comprising:
a voice recognition part which includes:
a microphone for detecting a voice signal from an elevator passenger;
a voice recognition control part which recognizes a voice signal detected by the microphone by way of a previously set voice recognition program, outputs a voice recognition command corresponding to a hall call and a floor selection and outputs a signal for a display of a voice recognition procedure by means of the audio recognition program and a result of the voice recognition;
a voice recognition database for storing the voice recognition program and a previously set voice recognition information;
a voice recognition time display part which is turned on and off in accordance with a display signal from the voice recognition control part; and
a voice recognition audible display part for outputting a voice signal in accordance with a display signal from the voice recognition control part;
a button input part for detecting a hall call signal and a floor selection signal from the passenger;
a control part for outputting an elevator operation control signal in accordance with a voice recognition command from the voice recognition part and a hall call signal and a floor selections signal detected by the button input part;
a protocol conversion part for converting an elevator operation control signal from the control part into a previously set communication protocol of an elevator manufacturer;
a transceiver part for transmitting an operation control signal converted by the protocol conversion part to the outside;
a display part allowing a passenger to recognize the hall call signal and the floor selection signal in accordance with an operation control signal from the control part; and
a protocol setting part for inputting a communication protocol information by the elevator manufacturer into the protocol conversion part.

2. The apparatus of claim 1, wherein said voice recognition control part outputs a flickering signal and a voice signal so that a passenger can recognize that a voice recognition is being performed by way of the audio recognition program in visual and audible ways.

3. The apparatus of claim 1, wherein said voice recognition time display part comprises:
a first lamp which is turned on when a voice recognition command is outputted from the control part; and
a second lamp which is turned on when a voice recognition command is not outputted from the voice recognition part.

4. A method for controlling a voice recognition apparatus for an elevator, comprising:
(a) a step in which a control part detects an operation control signal of an elevator from at least one among a voice recognition part and a button part;
(b) a step in which said control part judges if a voice recognition command is outputted from the voice recognition part when an elevator operation control signal is detected by way of the voice recognition part in the step (a);
(c) a step in which the control part outputs a corresponding operation control signal when the voice recognition command is outputted in the step (b); and
(d) a step in which a protocol conversion part converts an operation control signal outputted in the step (c) into a previously set communication protocol of an elevator manufacturer, and the converted operation control signal is transmitted to the outside by way of the transceiver.

5. The method of claim 4, wherein said step (a) includes:
a sub-step in which the voice recognition part outputs a signal for displaying a procedure of recognizing a hall call voice and a floor selection voice of a passenger by way of a previously set voice recognition program and a result of the voice recognition.

6. The method of claim 5, wherein a display signal of the procedure of recognizing the voice is a flickering signal and a voice signal casing a passenger to recognize that a voice recognition is being performed by means of the voice recognition program in visual and audible ways.

7. The method of claim 5, wherein a signal displaying a result of the voice recognition causes a previously set first lamp to turn on when a voice recognition command is outputted from the voice recognition control part and causes a previously set second lamp to turn on when a voice recognition command is not outputted from the voice recognition control part.
